(19) United States
(12) Patent Application Publication
(10) Pub. No.: US 2022/0067816 A1
(43) Pub. Date: Mar. 3, 2022

(54) METHOD AND SYSTEM TO DETECT ABANDONMENT BEHAVIOR

(71) Applicant: INTUIT INC., Mountain View, CA (US)

(72) Inventors: Issam MIYASSI, San Diego, CA (US); Byungkyu KANG, San Diego, CA (US); Disha SINGLA, San Diego, CA (US); Shivakumara NARAYANASWAMY, Mountain View, CA (US); Vitor R. CARVALHO, San Diego, CA (US)

(73) Assignee: INTUIT INC., Mountain View, CA (US)

(21) Appl. No.: 17/006,654

(22) Filed: Aug. 28, 2020

(51) Int. Cl. G06Q 30/06; G06N 20/00; G06Q 30/02

(52) U.S. Cl. CPC G06Q 30/0635; G06Q 30/0202; G06Q 30/0641; G06N 20/00

(57) ABSTRACT

Dynamic machine learning modeling within a special purpose hardware platform to determine platform abandonment risks for each user having exhibited a sequence of behaviors. The enclosed examples address a computer-centric and Internet-centric problem of a service provider system management to lower platform abandonment of users, and further increase product engagement.

### BACKGROUND

Users may access provided services using, for example, a client (e.g., a thin client) via web browsers or mobile applications on mobile computing devices. Users might have trouble discovering aspects of the provided services that will meet their needs without some assistance, especially if those features are located deep within the provided services. The users' failure to discover aspects of the provided services that will meet their needs may result in “churning,” which is the switching between brands of goods or service providers.

While some degree of churning is unavoidable due to consumer experimentation in an effort to maximize satisfaction with the value received for goods or services purchased, any business will wish to minimize churning since churning necessarily represents either customers that are at risk of being lost, either permanently or for a significant period of time.

Since the cost of acquiring a new customer (or winning back an old customer) is high, user abandonment can be a major expense for a service provider. The ability to identify and intervene with users who are likely to leave, or otherwise stop using products or services, can have a significant impact on a provider's bottom line. Thus, it is with respect to these considerations and others that the present disclosure has been made.

### BRIEF DESCRIPTION OF THE DRAWINGS

FIG. 1 illustrates an example server provider (SP) system in which certain examples of the present disclosure may be implemented.

FIG. 2 is a block diagram of an example computing device that may implement various features and processes as described herein.

FIG. 3 shows one example architecture that may be useable to determine a score signaling the likelihood that a user will abandon the SP system, in accordance with an example of the disclosure.

FIG. 4 shows one example of an intake manager (IM), configured to provide a framework for accessing raw or model produced data files, in accordance with an example of the disclosure.

FIG. 5 shows one example of a Common Schema Manager (CSM) usable within the contextual modelling platform (CMP) of FIG. 2, in accordance with an example of the disclosure.

FIG. 6 illustrates one example of a machine learning model hierarchy derived from a segment that is selected from a user base, in accordance with an example of the disclosure.

FIG. 7 shows one example of Machine Learning (ML) Models useable with the CMP of FIG. 2, in accordance with an example of the disclosure.

FIG. 8 shows one example of a process flow useable to train abandonment models, in accordance with an example of the disclosure.

FIG. 9 shows one example of a process flow useable in live production of the trained abandonment model.

### DETAILED DESCRIPTION

Examples described herein are configured to perform dynamic machine learning (ML) modeling techniques to determine, based on a user's sequence of behaviors on a particular software platform, how likely that user is to abandon that software platform. . The disclosed examples and principles address a computer-centric and Internet-centric problem related to service provider system management to reduce abandonment of the platform and further increase product engagement. The disclosed methods and system may be implemented as computer programs or application software on one or more computing devices that process user features collected by a data management system.

Abandonment indicates any user who has completely stopped using the service and is unlikely to return—e.g., does not complete a threshold task of the service before a predetermined deadline (e.g., does not complete their tax return before the recognized deadline), does not renew their subscription in the next billing cycle, or cancels their subscription. The present disclosure is directed towards predicting whether a user is likely to abandon, but, has not yet stopped using the product or service. As discussed herein, it has little value to produce an abandonment determination after the user reaches the point of no return: therefore, the models disclosed herein are directed to identifying a user prior to his/her stopping use of the platform or service and hopefully retain the user. Thus, the definition of abandonment employed herein may be a weaker one than some service provider's (in the sense that it is a more general definition that might typically be used by a provider). Instead, “abandonment” is defined herein as a reduction in activity. The specific definition of what constitutes “reduction” may vary between service provider, reflecting the provider's own policies, since these have direct impact on user behavior and decision making.

Machine learning is a field of study that gives computers the ability to learn without being explicitly programmed. Machine-learning explores the study and construction of algorithms, also referred to herein as tools, which learn from existing data and make predictions about new data. Such machine-learning tools operate by building a model from example training data to make data-driven predictions or decisions expressed as outputs or assessments (e.g., abandonment risks). Although example embodiments are presented with respect to a few machine-learning tools, the principles presented herein may be applied to other machine-learning tools.

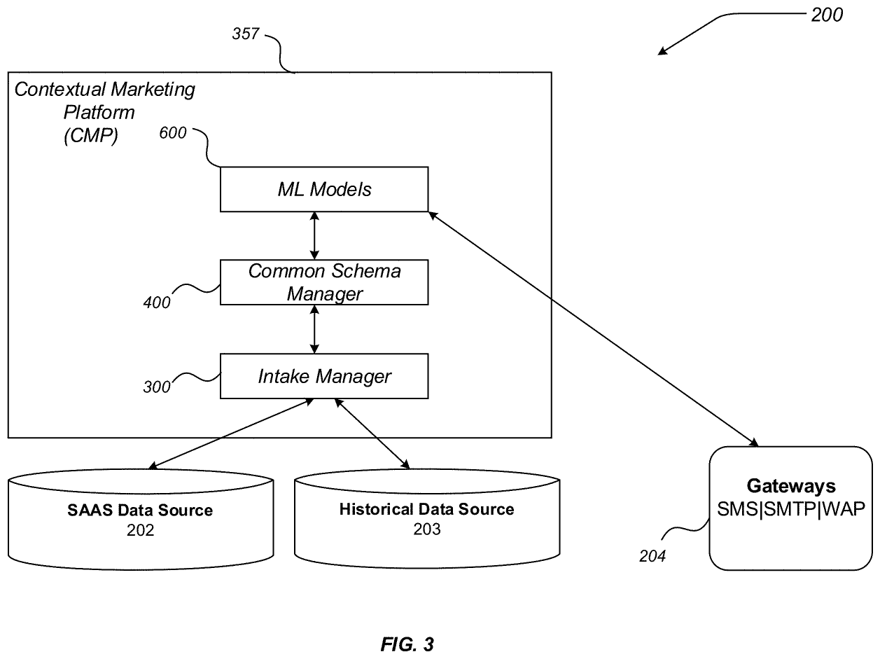

In accordance with the disclosed principles, users are not simply assigned to a large class and associated with a user behavior of that class, rather, each user's individual context and behavior is assessed by the machine learning model to determine a score signaling the likelihood of abandonment loss specific to the user. The machine learning model may further employ dynamic daily-reporting features to construct the behavioral sequence of an individual user. This is described in further detail below with respect to FIG. 3. In contrast to other approaches that might make use of only static (or slowly changing) features of the network, such as the reported income of a user, the disclosed machine learning model may also use dynamic features such as e.g., a sequence of clickstream data with the platform.

For the purposes of this disclosure, “clickstream data” is defined as an electronic record of a user's activity collected from one or more nonportable, portable, and mobile computers, electronic consoles, other communications means, tablets, cell phones, media players, set top boxes, other electronic devices, and other electronic media, including the Internet and other networked computing environments.

In some example embodiments, an abandonment probability score is a feature that can be incorporated into automated monitoring of the performance of contextual marketing systems or its components. The abandonment probability score may also be available to human marketers and data scientists who might want to interact with the system. However, it should be understood that some example embodiments operate automatically, absent such human interactions.

It is noted that while example embodiments herein disclose applications to SaaS, PaaS, or IaaS users, where the users are different from the service providers, other intermediate entities may also benefit from the principles disclosed herein. For example, the example embodiments disclosed herein may be applied to banking industries, cable television industries, retailers, wholesalers, or virtually any other industry in which that industry's customers interact with the services and/or products offered by an entity within that industry.

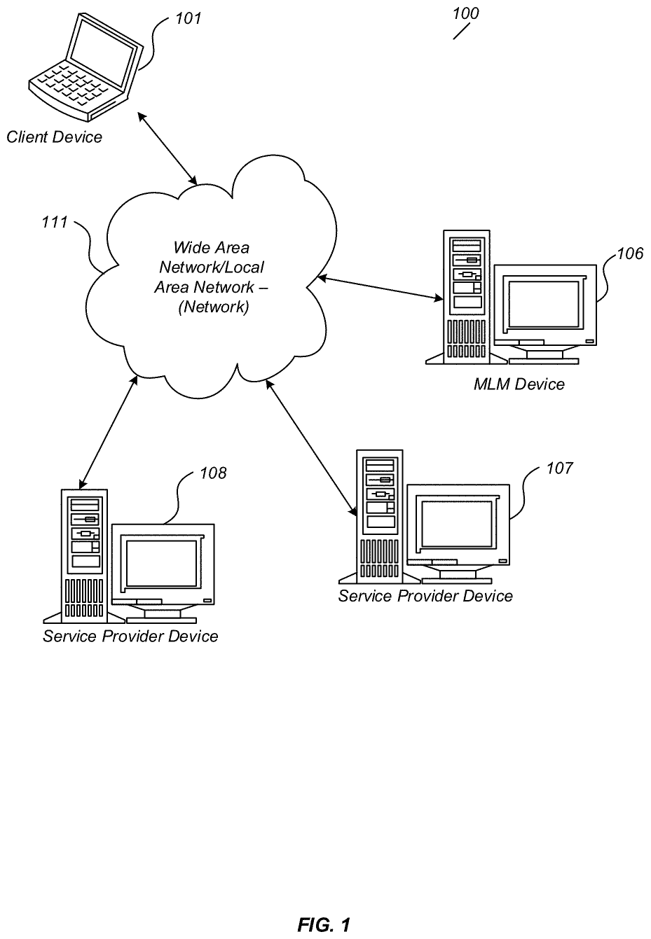

FIG. 1 illustrates an example server provider (SP) system 100 in which certain example embodiments of the present disclosure may be implemented. The example SP system 100 includes a network 111, client device 101, machine learning modeling (MLM) device 106, and service provider devices 107-108.

The network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one LAN to another. Furthermore, remote computers and other related electronic devices could be remotely connected to either LANs or WANs via a modem and temporary telephone link. Network 111 includes any communication method by which information may travel between computing devices.

The client device 101 may include virtually any computing device that typically connects using a wired or wireless communications medium such as telephones, televisions, video recorders, cable boxes, gaming consoles, personal computers, multiprocessor systems, microprocessor-based or programmable consumer electronics, network PCs, or the like. The client device 101 may further be configured to include a client application that enables the user to log into a user account that may be managed by the service provider. Information provided either as part of user account generation, user account utilization, and or other activity may result in providing various user profile information. Such user profile information may include, but is not limited to, type of user and/or behavioral information about the user.

The MLM device 106 may include virtually any network computing device that is specially configured to determine abandonment risks for each user having exhibited a sequence of behaviors. Devices that may operate as MLM device 106 include, but are not limited to, personal computers, desktop computers, multiprocessor systems, microprocessor-based or programmable consumer electronics, network PCs, servers, network appliances, and the like.

Although MLM device 106 is illustrated as a distinct network device, the disclosed principles are not so limited. For example, a plurality of network devices may be configured to perform the operational aspects of MLM device 106. For example, data collection might be performed by one or more set of network devices, while processing the collected data to determine the abandonment risks may be performed by one or more other network devices.

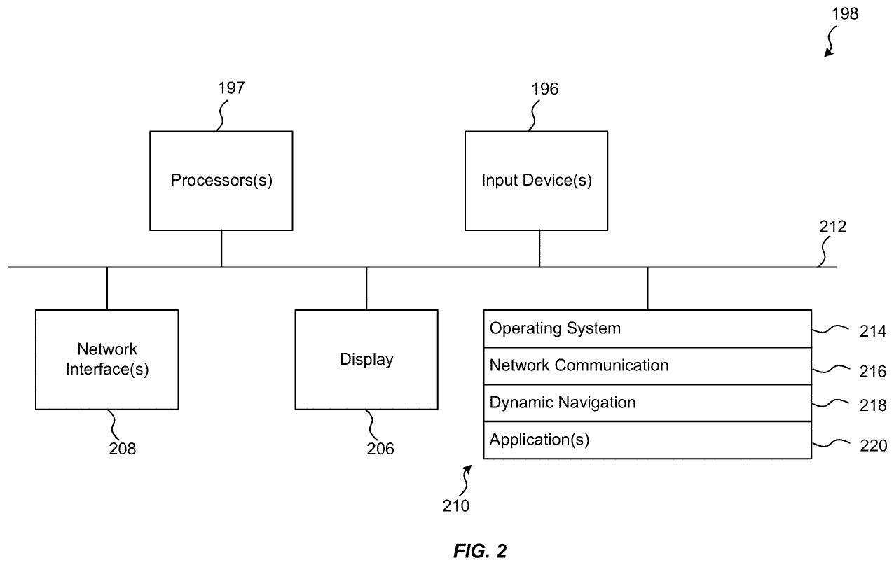

Service provider devices 107-108 may include virtually any network computing device that is configured to provide to MLM device 106 information including product usage characteristic information, user information, and/or other context information, including, for example, the number of bank accounts the user has added, the number of trips the user has reviewed, the ratio of business trips to personal trips, etc. In some example embodiments, service provider devices 107-108 may provide various interfaces including, but not limited to, those described in more detail below in conjunction with FIG. 2.

FIG. 2 is a block diagram of an example computing device 198 that may implement various features and processes described herein. For example, computing device 198 may function as MLM device 106, service provider devices 107-108, or a portion or combination thereof in some embodiments. The computing device 198 may be implemented on any electronic device that runs software applications derived from compiled instructions, including without limitation personal computers, servers, smart phones, media players, electronic tablets, game consoles, email devices, etc. In some implementations, the computing device 198 may include one or more processors 197, one or more input devices 196, one or more display devices 206, one or more network interfaces 208, and one or more computer-readable media 210. Each of these components may be coupled by a bus 212.

Display device 206 may be any known display technology, including but not limited to display devices using Liquid Crystal Display (LCD) or Light Emitting Diode (LED) technology. Processor(s) 197 may use any known processor technology, including but not limited to graphics processors and multi-core processors. Input device(s) 196 may be any known input device technology, including but not limited to a keyboard (including a virtual keyboard), mouse, track ball, and touch-sensitive pad or display. Bus 212 may be any known internal or external bus technology, including but not limited to ISA, EISA, PCI, PCI Express, USB, Serial ATA or FireWire. Computer-readable medium 210 may be any medium that participates in providing instructions to processor(s) 197 for execution, including without limitation, non-volatile storage media (e.g., optical disks, magnetic disks, flash drives, etc.), or volatile media (e.g., SDRAM, ROM, etc.).

Computer-readable medium 210 may include various instructions 214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from an input device 196; sending an output to a display device 206; keeping track of files and directories on computer-readable medium 210; controlling peripheral devices (e.g., disk drives, printers, etc.) which can be controlled directly or through an I/O controller; and managing traffic on bus 212. Network communications instructions 216 may establish and maintain network connections (e.g., software for implementing communication protocols, such as TCP/IP, HTTP, Ethernet, telephony, etc.).

Dynamic ML 218 may include instructions that perform the process for providing dynamic and deep navigation of web pages using keyboard navigation as described herein. Application(s) may be an application that uses or implements the processes described herein and/or other processes. The processes may also be implemented in operating system 214.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a backend component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the

API

In some implementations, an API call may report to an application the capabilities of a device running the application, such as input capability, output capability, processing capability, power capability, communications capability, etc.

FIG. 3 shows one example architecture 200 that may be used to determine a score indicating the likelihood that a user has abandoned or stopped using the service and is unlikely to return in accordance with the disclosed principles. Architecture 200 of FIG. 2 may include many more components than those shown. The components shown, however, are sufficient to disclose an illustrative example for practicing the disclosed principles. Architecture 200 may be deployed across components of FIG. 1, including, for example, the MLM device 106, the client device 101, and/or the service provider devices 107-108.

The architecture 200 includes a contextual modelling platform (CMP) 357, an SaaS data source 202 (repository), and a historical data source 203. The contextual modelling platform 357 also includes Machine Learning (ML) Models 600. Briefly, the ML Models 600 are employed to determine abandonment risk of each user.

Not all the components shown in FIG. 3 may be required to practice the example embodiments disclosed herein and variations in the arrangement and type of the components may be made without departing from the spirit or scope of the subject disclosure. As shown, however, architecture 200 further includes communication channel or communication gateways 204.

Although the SaaS data source 202 and the historical data source 203 are illustrated as distinct storage devices, the disclosed principles are not so limited. For example, one or a plurality of storage devices may be configured to perform the operational aspects of the SaaS data source 202 and the historical data source 203. For example, data collection might be performed by one or more set of storage devices.

In some examples, one machine learning solution includes multiple standalone machine learning models internally cascaded. A hierarchy of heterogeneous machine learning models may be implemented to blend different signals to achieve superior prediction accuracy. Signals may include, for example, clickstream data and historical data. The clickstream data can be combined with static signals to conflate the received data and train the heterogeneous machine learning models. Once conflated, the hierarchy of heterogeneous machine learning models may be trained to determine an abandonment probability score with superior prediction accuracy.

SaaS data source 202 may be implemented within one or more service provider devices 107-108 of FIG. 1. The SaaS data source 202 may be configured to store signal data such as clickstream data, a frequency of occurrence of clickstream signals on pages, page duration, page duration deviation, feature information, product and/or service use behaviors, and the like. SaaS data source 202 may also provide information about a time when such communications occur, as well as a physical location for which a user might be connected to during a communication.

The CMP 357 may also receive data from the historical data source 203. The historical data source 203 may include virtually any mechanism usable for storing and managing data including, but not limited to, files stored on a disk or other computer readable medium, an application, such as a database or spreadsheet, a web service, or the like. The historical data source 203 may receive and store, but is not limited to storing, historical data such as a customer's profile, including their billing history, platform subscriptions, feature information, content purchases, client device characteristics, clickstream data recovered at a seasonal interval (e.g., a user's interaction with the service platform at a previous year's tax return window), and the like. The historical data source 203 may also store publicly available information about a user, including identifiers, demographic information, or the like. In addition to data generated by or relating to a specific user, the historical data source 203 may also provide contextual information that is broadly applicable to a wide range of users, such as, but not limited to, a schedule of events relevant to a geographic area, or the like.

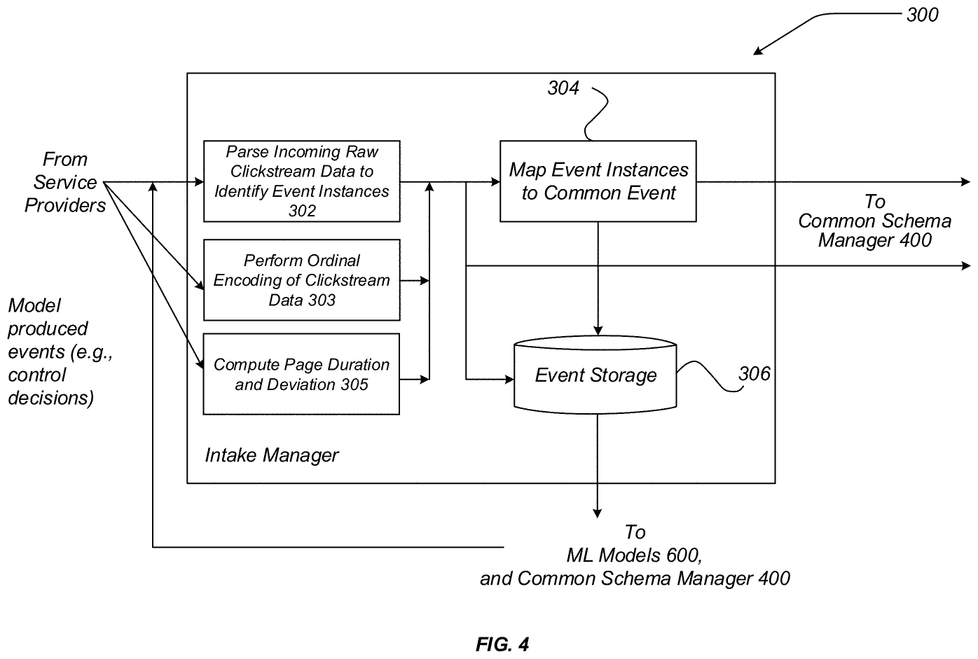

CMP 357 is streamlined to quickly receive and process the incoming data through various data cycles. For example, the CMP 357 may generate an abandonment probability score from more than one machine learning models based on data received from the SaaS data source 202 and the historical data source 203. As the raw data is processed into state vectors of attributes, and other supporting data, the raw data, and/or results of the processing of the raw data may be stored for later use. The machine learning models determine abandonment probability scores based on signal data of the SaaS data source 202 with static signals. The static signals are computer-generated signals that may be combined with clickthrough signals to conflate the data used to train the hierarchy of heterogeneous machine learning models. This is discussed in greater detail below with respect to FIG. 4. In one or more example embodiments, CMP 357 may be capable of analyzing historic data so that unanticipated insights may also be employed and used to further adapt the system.

Communication channels 204 may include one or more components that are configured to enable network devices to deliver and receive interactive communications with one or more users. In one example embodiment, communication channels 204 may be implemented within one or more of service provider devices 107-108, client device 101 and/or within networks 111 of FIG. 1.

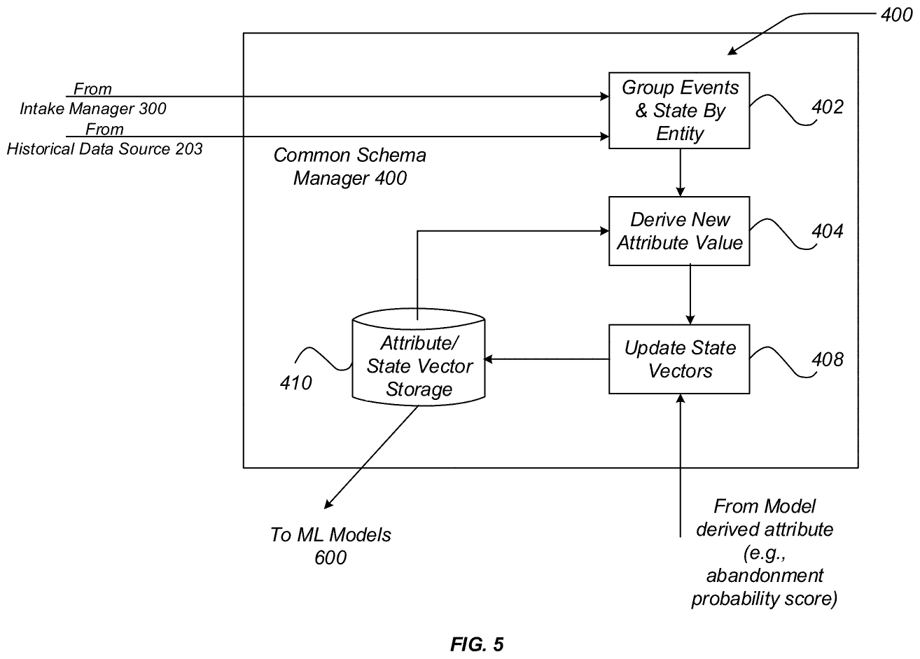

CMP 357 is configured to receive customer data from SaaS data source 202. CMP 357 may employ intake manager 300 to parse and/or store the incoming data. One example of an intake manager 300 is described in more detail below in conjunction with FIG. 4. The data may then be provided to common schema manager 400, which may compute various additional attributes, manage updates to state vectors for entities (users) within the system, and to further map raw data into common schema data. The common schema data may include attributes of the user based on the data received from the SaaS data source 202 and the historical data source 203. This process is discussed in greater detail below with respect to FIG. 5. The common schema data may then be used to support a number of models, including ML Models 600. ML Models 600 are configured to generate abandonment probability scores and indices that are then provided to common schema manager 400 to become part of the common schema data.

In some instances, it may also be possible to provide the raw data directly to the ML Models 600. This may be desirable when provider specific data that is not captured by the common schema nevertheless proves to be of high value for ML Models 600 or is otherwise useful in the operation of the CMP 357. This is discussed in greater detail below with respect to FIG. 5.

It should be noted that the components shown in CMP 357 of FIG. 3 are configured to execute as multiple asynchronous and independent processes, coordinated through an interchange of data at various points within the process. As such, it should be understood that the intake manager 300 and the common schema manager 400 may operate within separate network devices, such as multiple network devices, within the same network device within separate CPUs, within a cluster computing architecture, a master/slave architecture, or the like. In at least one example embodiment, the selected computing architecture may be specially configured to optimize a performance of the manager executing within it. Moreover, it should be noted that while the intake manager 300 and the common schema manager 400 are described as processes, one or more of the sub-processes within any of the managers 300 and 400 may be fully implemented within hardware or executed within an application-specific integrated circuit (ASIC), that is, an integrated circuit that is customized for a particular task.

FIG. 4 shows one example of an intake manager (IM) 300 configured to provide a framework for accessing raw or model produced data files that may include transactional and/or behavioral data for various entities, including users of a service provider.

IM 300 may receive data as described above at a specified interval to produce a real-time model and to generate the abandonment probability score. In some example embodiments, data may be received daily, hourly, or even in real time to generate the abandonment probability score. IM 300 may employ a sub-process 302 to parse incoming clickstream data to identify event instances. In some examples, the incoming clickstream data may also be parsed to locate new files and perform any copying of the files into various storage locations and registries, such as event storage 306. Parsing may include, among other actions, matching one or more data points from a given file to one or more users, extracting event types, event instances, or the like. Any data translations or registrations may also be performed upon the incoming data at sub-process 302. For example, the incoming clickstream data may include attached signals that may be separately processed as supplemental data for generating the abandonment probability score. In some embodiments, the clickstream data, as used herein, refers to the user's navigation history in terms of page views. The attached signals may not include the user's navigation history , per se, but may include, for example, the pages that the user skips, the characters entered on a specific page. For example, the supplemental predictors might include time spent by the user on each page, activity type (clicks, drags, scrolls, keyboard input, page transition, etc. and all derived metrics computed based on the aforementioned). The data, for example, the pages that the user skips or the characters entered on a specific page, can be derived in real-time by looking up the difference of the page viewed by this user and the common page view history stored in a file or a database.

IM 300 may also employ a sub-process 303 to perform ordinal encoding of the clickstream data to reduce the cardinality of clickstream feature. For example, the clickstream data may be transformed into numerical labels or nominal categorical variables to reduce the cardinality of clickstream feature (dimensionality reduction of a feature that is non-numeric and sequential) and improve feature processing time. In some examples, clickstream data may be encoded in the order of arrival and encoded into integers.

For example, a user may enter at the client device 101 a lengthy string that exceeds 500 characters, which should be considered as a single-entry response. The process 300 may transform the lengthy string that exceeds 500 characters into numerical labels or nominal categorical variables. For example, there are tens of thousands of unique pages in this pattern ‘S1040PER-23hzs231s8fy983hbs’As there are thousands of pages with the same prefix (indicating form type), the disclosed embodiments may 1) first truncate the unique identifier part, 2) map this page to a prefix token as e.g., ‘S1040PER’ then ‘S1040’. This is one example of many similar cases. Then, according to the disclosed principles, 3) this “reduced” string will be mapped to an index (in integer) using a mapping table stored in the system. ‘S1040’→32 According to this example, the long screen id with a lengthy identifier has been mapped to an integer “32”.

Moreover, IM 300 may employ a sub-process 305 to determine page duration and page duration deviation. The page duration may be computed by caching a timestamp marked on a preceding screen visited by the same user and determining the time difference between the current page timestamp with that of the preceding page. The sub-process 305 may determine page duration deviation by computing the difference between the page duration and the mean and/or medium page duration time spent by all users (per each unique screen). The average duration per page is precomputed based on the previous year data.

The data may then be provided to sub-process 304, where various event instances may be identified and mapped to common events. For example, a service provider may identify events that occurred during the specified interval. Sub-process 304 may examine the incoming event instances, and so forth, to generate common events with common terminology, form, formats, and so forth, to be provider agnostic. The common events may include, for example, an average page duration on a specific page, average clickstream data received on a specific page, etc.

FIG. 5 shows one example of a Common Schema Manager (CSM) 400 that may be used within the CMP 357 of FIG. 3. It should be noted that CSM 400 may include more or less components than those shown in the figure. However, those components shown are sufficient to practice the disclosed innovations.

The user may be defined as an entity, where attributes of the user are considered. For example, user attributes may include the name of business, business type, whether the user is the business owner, etc. Other attributes may include the status of the user, the age of the user's membership/trial, the subscribed platform, the user engagement (e.g., clickstream data) on the user device within a predetermined time period, the status of the user's device (web interface or mobile device), etc.

The clickstream data can include user engagement data such as the user connecting a separate account (i.e., bank account) to the provider's platform, the user categorizing a transaction, the user manually adding data (i.e., an expense), the user enabling a feature of the platform (i.e., mileage tracking), the user categorizing data (i.e., a trip), the user requesting assistance, technical help, or querying a self-help assistance guide provided by the provider's platform, etc. It is noted that while many attributes of an entity may be directly obtained from the raw data, or as a result of actions performed within IM 300, there are some datapoints that may also be computed or otherwise derived from the clickstream data. CSM 400 therefore is further configured to compute attributes for users. CSM 400 may also update computations given current state data, historical data, or the like. For example, the CSM 400 may receive prior year data distributions to improve measurement and capability of estimating expected traffic that qualifies based on a threshold.

As shown in FIG. 5, CSM 400 receives data from IM 300 and/or historical data source 203 at sub-process 402, where the received data may be grouped by entity. Thus, clickstream data, state data, historical data, and so forth may be organized by entity in one example embodiment. The results may flow to sub-process 404 where derived attributes may be computed and provided to sub-process 408 to fill and/or update state vectors for entities in attribute/state vector storage 410.

Sub-process 404 may compute a variety of attributes, including, but not limited to, recursive independent attributes, attributes having complex forms, attributes that may be computed from data provided by predictive models, user clusters, including time series clusters, usage histogram clusters, cluster scoring, or the like. Computed attributes may also include values constituting of category, cyclical values, or the like. In any event, the computed attributes may be used to update state vectors for e.g., an entity, which may be performed by sub-process 404. The updated state vectors may be extracted by sub-process 404 from the data stores and provided to sub-process 408. While shown within CSM 400, attribute/state vector storage 410 may reside in another location external to CSM 400. The attribute/state vector storage 410 is illustrated merely to show that data may be used and/or provided by different sub-processes of CSM 400. For example, among other things, event storage 306 and/or state vector storage 410 may provide various event data requirements used to provide data for initialization of an attribute or to derive attributes that might be computed, for example, from ‘scratch’, or the like. Attribute/state vector storage 410 may also store and thereby provide attribute dependency data, indicating, for example, whether an attribute is dependent upon another attribute, whether a current dependency state is passed to attributes at a computation time, whether dependencies dictate a computation order, or the like. Output of CSM 400 may flow, among other places, to ML Models 600 of FIG. 3, and conversely, those components may provide updated attribute information to sub-process 408 in order that it may be added to attribute/state vector storage 410.

As noted, ML Models 600 primarily (although not exclusively) receive data after it has been mapped to the common schema. The data available in the event storage 306 or attribute/state vector storage 410 contains a wide range of information about individual accounts (e.g., historical data such as a date an account was established) and clickstream data associated with that account (e.g., number of bank accounts added, third party add-on subscriptions).

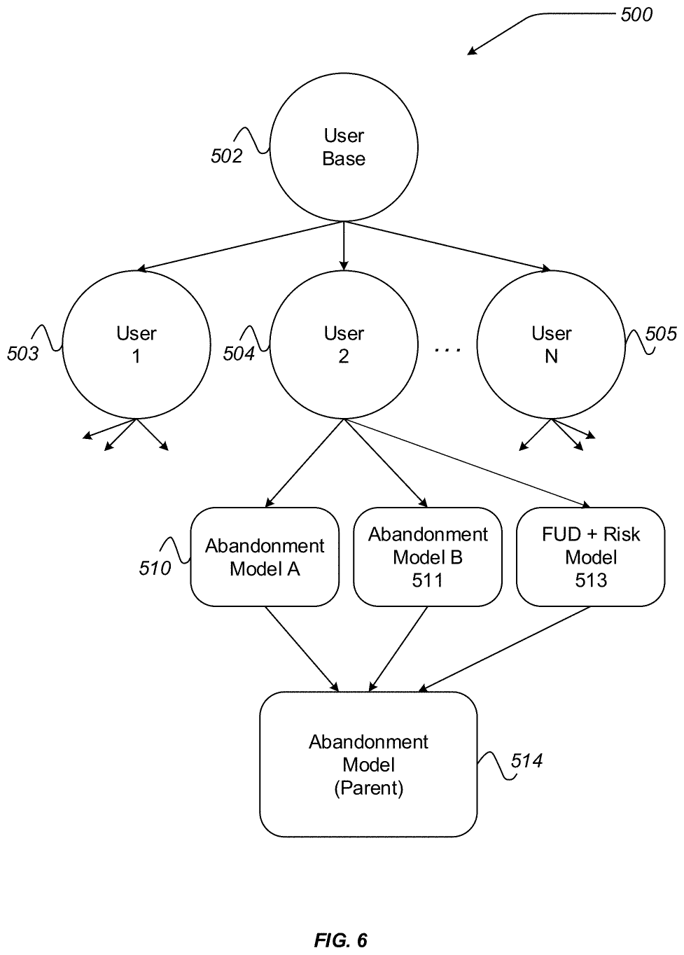

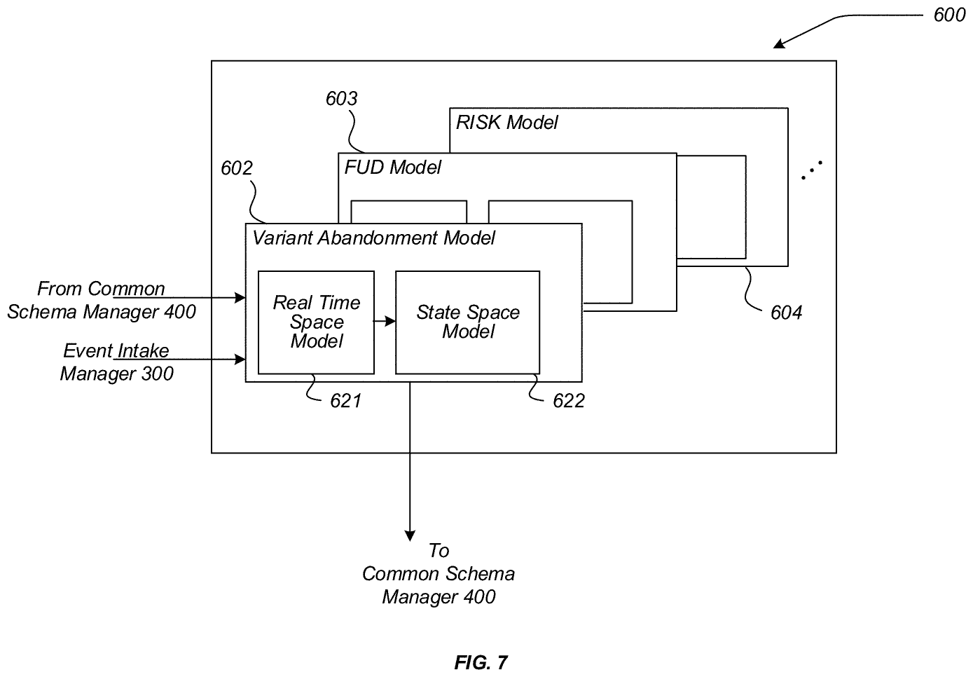

A machine learning (ML) method model framework that includes multiple sub-ML models may be implemented herein. An example ML model includes a random forest, XGBoost, or random decision forests model used for classification, regression and other tasks. The random forests model operates by constructing a multitude of decision trees at training time and outputting the class that is the mode of the classes (classification) or mean prediction (regression) of the individual trees. The ML model produces sequences with certain statistical properties. The purpose of the ML model is to produce multiple standalone ML models internally cascaded, where each is operable to produce a ML model based on a unique sequence of user behavior. The multiple sub-ML models are organized as a hierarchy of heterogenous ML models operable to blend different signals to achieve a median ML model. This is discussed in greater detail below with respect to FIGS. 6 and 7.

To determine if a user is an abandonment probability risk, a behavioral sequence is constructed for that user and evaluated with respect to the multiple standalone ML models to achieve a supreme prediction accuracy.

FIG. 6 illustrates one example of an ML hierarchy 500 generated for a user 504 that is selected from user base 502. As shown, an abandonment model A 510, an abandonment model B 511, a fear-uncertainty-death (FUD) and RISK model 513 may be generated for the user 504. The FUD model is a ML model used for calculating a failure probability during a predetermined time interval. The RISK model may be a ML model used for calculating a risk score and generated based on data accessed from the SaaS data source 202 and historical data source 203. This is described in greater detail below.

It is noted that similar sub-ML models may also be generated for any or all other users, that is, 503, 505, and others that have been omitted from FIG. 6 for clarity. There may be multiple ML models for any given user of the user base because the ML model may be highly parameterized, for example, allowing for multiple definitions of abandonment. In such cases, a user would receive multiple abandonment probability scores, one from each variant. Moreover, it can be useful to run multiple variants of the ML model in production because there are multiple uses for its output, including, but not limited to automated decisioning, model performance monitoring, or the like. In any event, the ML hierarchy 500 may be used to track the individual ML model for multiple segments of the total user base for a service provider.

The abandonment model A 510 and the abandonment model B 511 may be individually configured to be applied to users based on variants of parameter settings. In this instance, multiple variants of the ML model may produce separate abandonment probability scores for each user (one per variant). While two variant abandonment models are illustrated herein, it is conceivable that more than two variant ML models may be implemented to generate scores for each ML model. The scores from the set of ML Models (variants, FUD and RISK) may be averaged to generate data to train an abandonment model 514; the score resulting from the abandonment model 514 represents the abandonment probability score for the user.

The abandonment probability score generated by the ML model may be based on a sequence of clickstream data, used to train the ML model. As discussed herein, the clickstream data is data recorded as a result of actions undertaken by a user. In one example embodiment, the sequence includes measurements of user actions over a specified time interval. The user actions are defined by a select set of attributes either drawn directly from the common schema or values derived from basic measurements in the common schema. The data may be represented on an hourly interval, in one example, to provide a high resolution for which the full range of reported data is typically available. However, higher resolution (e.g. every 5 minutes) or lower resolution (e.g., bi-daily) representations could also be used.

FIG. 7 shows one example of ML Models 600 that may be used with the CMP 357 of FIG. 3. As shown, ML Models 600 may include models 602-604. Each model 602-604 may include sub-components. ML models 602-604 may include more or less sub-components than those shown in FIG. 7. However, the sub-components shown are sufficient to disclose an illustrative example for practicing the subject disclosure.

As shown in FIG. 7, for example, ML models 602 include a real-time space model 621 and a state-space model 622. The real-time space model 621 represents a pattern recognition component based on a real-time space behavioral model. In one example embodiment, real-time space model 621 may be implemented within the ML framework. The real-time space model 621 is trained and calibrated using clickstream data, as discussed further below.

The state-space model 622 represents a pattern recognition component based on a state-space behavioral model. In one example embodiments, state-space model 622 may be implemented within the ML framework. The state-space model 622 is trained and calibrated using historical data, as discussed further below.

Once ready, the real-time space model 621 is deployed to a production system. As baseline user behavior evolves, the real-time space model 621 may be retrained. In some example embodiments, the retraining may be based on monitoring the performance of the production system, for example, the accuracy of the predictions. However, retraining may be based on other criteria, including a schedule, detected changes in the baseline subscriber behavior, or any of a variety or combination of other criteria. Moreover, the real-time space model 621 may receive common events from the event storage 306 based on identified and mapped various event instances, and/or attribute/state vector data from the attribute/state vector storage 410. The real-time space model 621 may infuse the received data with random data (noise) with the clickstream data provided in the common events from the event storage 306 for training and testing purposes of the ML model. The random data will train the real-time space model 621 to account for random data in the clickstream data and to make intelligent determinations despite the presence of the noise. In other example embodiments, the real-time space model 621 incorporates delayed processing features that are operable to simulate real-world delays that can be observed intermittently from the feature processing pipeline due to various reasons, for training and testing purposes of the ML model. The delayed processing features may include a time delay between 0-30 seconds inserted randomly within the clickstream data.

ML Models shown in FIG. 7 indicate that abandonment probability modeling is based, at least in-part, on a state-space model of subscriber behavior, as illustrated by the state-space model 622. The state-space model can represent a sequence of events. For example, if a subscriber has not entered account information by day 20, a state-space model would capture this order of events, while traditional models would likely lose this information. A traditional modeling approach may only retain this information, but only through an encoding of sequential behavior in a “flat” format. Such a process requires expensive feature selection via either an ad hoc determination or an exhaustive automated approach, or, if feature selection is neglected, threatens model quality degradation due to the large number of likely encodings. The state-space approach captures these important relationships by design.

When constructing a state-space model, the user's abandonment probability is not typically something that can be measured directly. It is not captured explicitly in a provider's data. Instead one expects to observe the side effects of a user's state, e.g., uploaded information, enrolling into various platforms, and the like. User state may be considered to be deduced from a subscriber's behavior, or based on historical data. Moreover, a user's state may change over time, necessitating accurate deduction of state using the latest available behavioral data.

As disclosed herein, the models 602-604 may be built upon the ML framework. ML techniques can be used to rank the importance of variables in a regression or classification problem in a natural way. For example, the Shapley method, which is one of several algorithms available herein, can be implemented for feature importance analysis in a variant abandonment model 602. For each feature, a shap value is calculated for every feature value. The feature value is the average of this feature value's marginal contribution across all permutations of other features. In various example embodiments, different machine-learning tools are used. For example, Multinomial Naive Bayes (MNB), Support Vector Machines (SVM), multinomial Logistic Regression (LR), Random Forest (RF), Gradient Boosted Trees (GBT), neural networks (NN), matrix factorization, and other tools may be used for generating loss risk models. The specific model is chosen based on the use case, such as random forests modeling being chosen as a preferred method to handle sparse data.

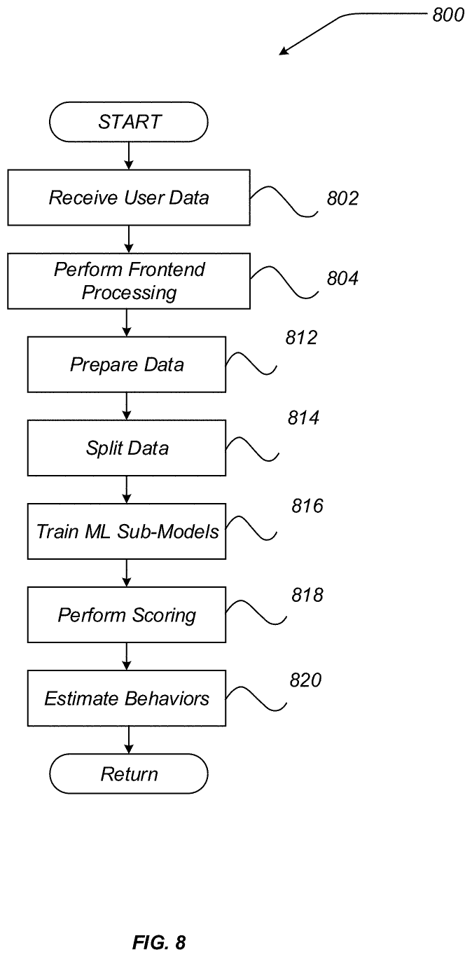

The operation of certain aspects of the ML Models of FIG. 7 are now described with respect to the process 800 illustrated in FIG. 8, which may be used to train abandonment probability ML models. Process 800 may be implemented within any one or more of the models 602-604 of FIG. 7, which operate within CMP 357 of FIG. 2.

Process 800 may begin at block 802, where user data is received and or accessed. The user data may be extracted from a representative set of a service provider's data set. In one example embodiment, the received data is raw data from the service provider's data set (though data may also be received from other sources).

At block 804, various frontend processing may be performed on the data, including those actions discussed above in conjunction with FIGS. 4-5, where the raw data may be parsed, and mapped to a common schema. Frontend processing may also include mapping a user to user base segments where the user base has been partitioned as described in conjunction with the description of FIG. 6.

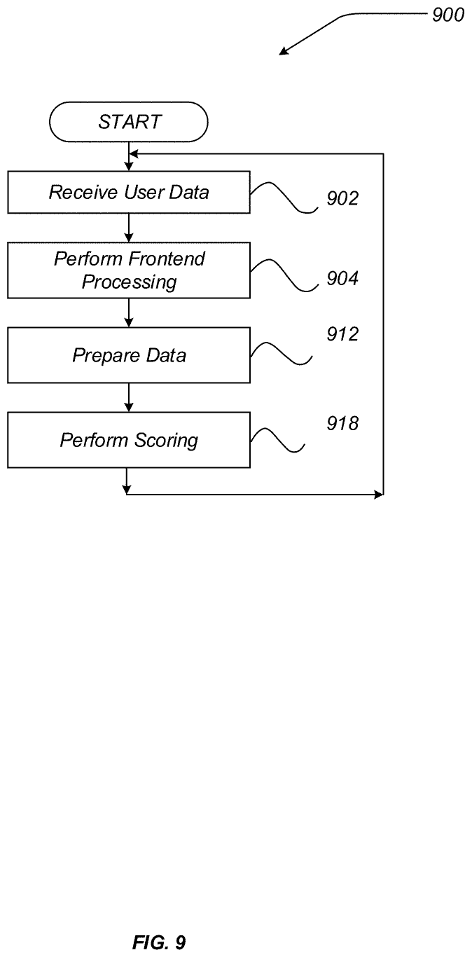

Before performing training with the data (or later performing the operational process 900 of FIG. 9), a number of data preparation steps may be performed. The same data preparation steps (including mapping event instances to common event at sub-process 304 or deriving new attribute value at sub-process 404) may be carried out for both model training and use of the model in operation, as discussed below in conjunction with FIG. 9.

Data preparation includes constructing sequences of behavioral observations for the users and determining an abandonment label for model training and (once enough time passes for it to become available) operational model performance monitoring. For model training and calibration, the prepared data may be split into independent sets for training, testing, and validation.

At block 812, further data preparation actions are performed including constructing behavioral sequences. Moreover, daily time series of subscriber behavior are constructed from common schema attributes. Several considerations are made while constructing the sequences. One such consideration includes selecting the features of interest. To improve model quality and robustness (in part by balancing the amount of available training data and model complexity) only a few select common schema attributes may be used. To determine which features to use, many potential models are constructed and tested. The best performing models, and the features associated with them, are selected. The determination of “best” does not imply simply selecting the features that appear in the single highest performing candidate, but in selecting features common to several of the highest performing models. That is, features are selected for both absolute performance and robustness.

Depending on the feature in question, it may be desirable to aggregate several discrete events to map the data to a daily sequence used by the model.

The abandonment probability model is more than pattern matching tools. The resulting ML model is also used to directly recommend future user actions. Moreover, in some examples, a ML model is computed for users who did not abandon. The label sequence is used to determine which users belong to which group.

While the pattern matching approach includes splitting users into groups of those who have abandoned and those who have not, if sufficient data is available, greater accuracy can be achieved by subdividing the general population into multiple groups. For example, different platform subscription can substantially change the utility of the provided service and therefore the decision processes of users. For example, the service provider may provide multiple platforms available to a user (i.e., Quickbooks Essentials®, QuickBooks Plus®, etc.). Instead of simply creating one ML model for general abandoners and on for general non-abandoners, separate ML models can be trained for users associated with each individual platform offered by a service provider. The general procedure remains unchanged: ML models for each group are trained, and the classification of a new behavioral sequence is determined by finding which of all the ML models is most likely to have produced the sequence.

In any event, upon preparing the data at block 812, process 800 proceeds to block 814 where data may be split into three non-overlapping sets: train, test, and validate sets. The training set contains examples of abandoners and non-abandoners. It is not necessary that the proportion of abandoners and non-abandoners be the same in the training set as in live data. For example, the training set may consist of approximately half abandoners and half non-abandoners.

The test set is used to get an unbiased estimate of model performance (since the training and validation sets were used to determine model settings). It should also contain the natural proportion of abandoners to non-abandoners.

At block 816, the ML model framework is employed to train the model. The training set is used to train abandonment probability models. Process 800 continues at block 818, where scoring and classifying of sequences for the user framework is performed. To test the model and use it in operation, it is necessary to have a method to score sequences given a model. Several approaches may be employed. Once the likelihood that a model produced a given behavior sequence is computed, the task is predicted. The task may be predicted by computing the likelihood that a behavioral sequence was produced by the non-abandonment ML model (i.e., the FUD or RISK model). The likelihood that a behavioral sequence was produced by the abandonment ML model is computed. The two values are compared, and in some examples of the disclosure, averaged, to predict that the user is an abandonment risk. In some example embodiments, the user is determined to be an abandonment risk if the abandonment ML model likelihood is greater than the non-abandonment ML model likelihood. In other example embodiments, the abandonment ML model(s) likelihood is averaged with the non-abandonment ML model(s) likelihood to determine an abandonment model 514 (see FIG. 6).

Although typically, the sequence length for the abandonment and non-abandonment ML models is identical, it is relevant to account for sequence length when comparing likelihoods from different ML models. Furthermore, a normalization scheme may be used to account for a systematic error introduced by differences in sequence length (if any) between the abandonment/non-abandonment ML models.

Continuing at block 820, the operating point is selected for model calibration and then used for estimating a behavior. The offset is a relevant parameter. For example, if it is large (and positive) only sequences that are much more likely to have come from the non-abandonment ML model are identified as non-abandonment risks. The value is selected during model testing, this is the calibration step and is distinct from model training (at block 816). Choosing the offset value does not modify the ML models themselves, rather, this act is to set the operating point, i.e., the threshold which is employed to declare a user an abandonment risk.

The predicted performance may be stored, in particular, for use later on when evaluating the performance of the model in production (e.g., as part of block 918 in FIG. 9). Also, operational data should be statistically similar to data used during training (if it is not, it may be necessary to retrain the model) so a record of the training data sufficient to carry out such comparison may be stored. Process 800 may then return to a calling process, after block 820.

FIG. 9 shows one example of a process 900 useable in live production of the trained ML models. It is noted that many of the actions performed during the production use of the ML models are substantially similar to those performed to train the models. However, several actions performed during training need not be performed during production.

Process 900 is an example where a trained model is used in production to determine the current abandonment probability risk for users. The model results are then appended to the common schema.

Thus, process 900 begins at block 902, where raw user data is received, as discussed above in conjunction with block 802 of FIG. 8. At block 904, frontend processing substantially similar to that of block 804 of FIG. 8 is performed.

At block 912, preparation of the data, substantially similar to those actions described above in conjunction with FIG. 8, may be performed. That is, preparation may include for example, building sequences of discretized data, performing normalization, and so forth, however, no abandonment labels are computed. Indeed, this is not possible during the period in which an abandonment prediction has value: i.e., before the point of abandonment. In any event, abandonment labels are not required in production to predict abandonment probability risk. At block 918, since the ML models are already trained and tuned, the models are retrieved and used to perform scoring of the users.

The abandonment probability score may serve multiple purposes, for example, to selectively send messages to users based on their abandonment probability score. As used herein, the term “message” refers to a mechanism for transmitting an offer or offering to the user. The offer or offering may be embedded within a message having a variety of fields. The fields may include how the message is presented, when the message is presented, or the like. In some examples, a message having the offer may be selectively intended to reduce the abandonment probability score.

The abandonment probability score may also be implemented to inform an automated contextual marketing function, human marketers and data scientists. The abandonment probability score is a feature that can be used by the automated contextual marketing model to refine decision making for selectively marketing new features to a user. Moreover, the abandonment probability score may also be incorporated into automated monitoring of the performance of the contextual marketing systems or its components. The abandonment probability score may also be available to human marketers and data scientists who might want to interact with the system. However, it should be understood that some embodiments operate automatically, absent such human interactions.

Rather than a single abandonment model (such as model 602 of FIG. 7), many models (e.g., models 602-604 of FIG. 7) may be available in production. In some example embodiments, a model may be retrained on new data, so some current and some previous versions of one model may be available.

Process 900 may continue to receive user data at block 902 and repeat the steps discussed above. While process 900 appears to operate as an “endless” loop, it should be understood that it may be executed according to a schedule (e.g., a process to be run hourly, bi-daily, daily, etc.) and it may be terminated at any time. Moreover, process 900 may be configured to perform asynchronously as a plurality of process 900s. That is, a different execution of process 900 may be performed using different ML models at block 918, using different filter criteria, and/or even based on the service provider's user base.

It will be understood that each block of the processes, and combinations of blocks in the processes discussed above, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multiprocessor computer system. In addition, one or more blocks or combinations of blocks in the illustration may also be performed concurrently with other blocks or combinations of blocks, or even in a different sequence than illustrated without departing from the scope or spirit of the subject innovation. Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware-based systems, which perform the specified actions or steps, or combinations of special purpose hardware and computer instructions.

What is claimed is:

1. A computer implemented method for determining a probability of a user abandoning a software-based flow, said method being performed on a computing device and executed by a processor, said method comprising:
retrieving from at least one data source, data indicating a user's sequence of behaviors;
training at least one machine learning (ML) model based on the user's sequence of behaviors; and
generating an abandonment probability score for the user based on the user's sequence of behaviors and the trained ML model, wherein the abandonment probability score includes an average abandonment probability score of generated scores from more than one of a variant abandonment model, a fear-uncertainty-death (FUD) model, and a RISK model; and
sending the abandonment probability score to the at least one data source to be included in the data indicating the user's sequence of behavior.

2. The method of claim 1, wherein retrieving the data includes processing the data indicating the user's sequence of behaviors by infusing the data with random data to train the at least one ML model to account for random data when generating the abandonment probability score.

3. The method of claim 1, further comprising parsing the data indicating the user's sequence of behaviors to identify event instances and mapping the event instances to common events, wherein parsing includes matching one or more data points from a given file to one or more users, extracting the event instances.

4. The method of claim 1, wherein the data indicating the user's sequence of behaviors includes attached signals, that may be separately processed as supplemental data for generating the abandonment probability score.

5. The method of claim 1, further comprising performing ordinal encoding of the data indicating the user's sequence of behaviors to identify event instances and mapping the event instances to common events, wherein the data is transformed into numerical labels or nominal categorical variables to reduce cardinality in the data and improve processing time.

6. The method of claim 1, further comprising determining page duration and page duration deviation to identify event instances and mapping the event instances to common events.

7. The method of claim 6, wherein the page duration is computed by caching a timestamp marked on a preceding screen visited by the user and determining a time difference between a current page timestamp with the timestamp on the preceding screen.

8. The method of claim 6, wherein the page duration deviation is computed by computing a difference between the page duration and a mean and/or medium page duration time spent by all users.

9. The method of claim 1, wherein the FUD model is used for calculating a failure probability during a predetermined time interval and is generated based on the retrieved data.

10. The method of claim 1, wherein the RISK model is a ML model used for calculating a risk score and is generated based on the retrieved data.

11. The method of claim 1, wherein the more than one variant abandonment model includes a first variant abandonment model and a second variant abandonment model, each based on a variant of parameter settings for the user.

12. The method of claim 1, wherein each of the more than one variant abandonment model, the fear-uncertainty-death (FUD) model, and the RISK model includes a real-time space model and a state-space model, where the real-time space model is trained and calibrated using the data indicating the user's sequence of behaviors, where the state-space model is trained and calibrated using historical data.

13. A computing system for determining a probability of a user abandoning a software-based flow, the system comprising:
one or more processors; and
one or more non-transitory computer-readable storage devices storing computer-executable instructions, the instructions operable to cause the one or more processors to perform operations comprising:
retrieving from at least one data source, data indicating a user's sequence of behaviors;
training at least one machine learning (ML) model based on the user's sequence of behaviors; and
generating an abandonment probability score for the user based on the user's sequence of behaviors and the trained ML model, wherein the abandonment probability score includes an average abandonment probability score of generated scores from more than one of a variant abandonment model, a fear-uncertainty-death (FUD) model, and a RISK model; and
sending the abandonment probability score to the at least one data source to be included in the data indicating the user's sequence of behavior to train the at least one ML model.

14. The system of claim 13, wherein retrieving the data includes processing the data indicating the user's sequence of behaviors by infusing the data with random data to train the at least one ML model to account for random data when generating the abandonment probability score.

15. The system of claim 13, wherein the data indicating the user's sequence of behaviors includes attached signals, that may be separately processed as supplemental data for generating the abandonment probability score.

16. The system of claim 13, wherein the FUD model is used for calculating a failure probability during a predetermined time interval and is generated based on the retrieved data.

17. The system of claim 13, wherein the RISK model is a ML model used for calculating a risk score and is generated based on the retrieved data.

18. The system of claim 13, wherein the more than one variant abandonment model includes a first variant abandonment model and a second variant abandonment model, each based on a variant of parameter settings for the user.

19. The system of claim 13, wherein each of the more than one variant abandonment model, the fear-uncertainty-death (FUD) model, and the RISK model includes a real-time space model and a state-space model, where the real-time space model is trained and calibrated using the data indicating the user's sequence of behaviors , where the state-space model is trained and calibrated using historical data.

20. A computer implemented method for determining a probability of a user abandoning a software-based flow, said method being performed on a computing device and executed by a processor, said method comprising:
retrieving from at least one data source, data indicating a user's sequence of behaviors;
training at least one machine learning (ML) model based on the user's sequence of behaviors; and
generating an abandonment probability score for the user based on the user's sequence of behaviors and the trained ML model, wherein the abandonment probability score includes an average abandonment probability score of generated scores from more than one of a variant abandonment model, a fear-uncertainty-death (FUD) model, and a RISK model; and
selectively send at least one message to the user based on the generated abandonment probability score.
